(19) United States
(12) Patent Application Publication
(10) Pub. No.: US 2010/0182897 A1
(43) Pub. Date: Jul. 22, 2010

(54) SIGNAL DETECTING METHOD FOR SPATIAL MULTIPLEXING MULTIPLE-INPUT MULTIPLE-OUTPUT SYSTEMS

(75) Inventors: Kyung-Hi Chang, Seoul (KR); Manar Mohaisen, Incheon (KR); Hongsun An, Incheon (KR)

Correspondence Address: Jefferson IP Law, LLP, 1130 Connecticut Ave., NW, Suite 420, Washington, DC, 20036, US

(73) Assignee: Industry Collaboration Foundation of INHA UNIVERSITY, Incheon (KR)

(21) Appl. No.: 12/392,758

(22) Filed: Feb. 25, 2009

(30) Foreign Application Priority Data
Jan. 20, 2009 (KR) 10-2009-0004541

(51) Int. Cl. H04J 11/00

(52) U.S. Cl. 370/208

(57) ABSTRACT

A method for detecting signals in spatial multiplexing multiple-input multiple-output (MIMO) systems using a QR-decomposition with M (QRD-M) algorithm is provided. The method includes receiving signals, limiting upper and lower bounds of a complexity in a QR-decomposition with M (QRD-M) algorithm, and detecting the received signals using the QRD-M algorithm. The signal detecting method can effectively reduce the amount of operation generated while detecting signals, using the QRD-M algorithm where the upper and lower bounds of the complexity are limited.

### PRIORITY

This application claims the benefit under 35 U.S.C. § 119(a) of a Korean patent application filed in the Korean Intellectual Property Office on Jan. 20, 2009 and assigned Serial No. 10-2009-0004541, the entire disclosure of which is hereby incorporated by reference.

### BACKGROUND OF THE INVENTION

1. Field of the Invention

The present invention relates to signal detecting systems, and more particularly, to a method that detects signals in spatial multiplexing multiple-input multiple-output (MIMO) systems using a QR-decomposition with M (QRD-M) algorithm.

2. Description of the Related Art

In recent years, the wireless communication has undergone rapid growth, and a variety of multimedia services in a wireless communication environment must be developed to cater to this expanding market. To this end, techniques are being developed to increase both the transmission amount and transmission rate of data. In particular, a variety of methods have been developed to efficiently use limited frequencies. An example of the techniques is a multiple-input multiple-output (MIMO) technique.

The MIMO technique is a system where multiple antennas are used at both the transmitter and the receiver. This MIMO technique has attracted interest from researchers and has been actively studied because it allows the channel transmission capacity to increase in proportion to the number of antennas without additionally allocating frequency or transmission power, compared to the system using a single antenna.

The channel capacity of the MIMO systems depends on a signal detecting method used at the receiver to restore blocks of transmitted symbols. To simultaneously achieve higher performance and lower complexity, interest regarding signal detecting methods used in the MIMO systems is gradually increasing.

Conventional MIMO systems have employed a maximum likelihood (ML) detection, as a signal detecting method, which can provide optimum performance. This ML detecting method is, however, disadvantageous in that, since it must perform a consumption search to obtain an ML solution, it is not practical if the modulation size is fixed and if the problem size is relatively large which is defined by the number of transmitted symbols through the different antennas.

To resolve this problem, a variety of detecting methods other than the ML detecting method have been developed. Examples of the methods are a sphere decoding (SD) algorithm and a QR-decomposition with M (QRD-M) algorithm.

The SD detecting method closely matches the performance output of the ML detecting method. On the contrary, the SD detecting method can significantly reduce the complexity, compared to the ML detecting method. The SD detecting method, however, shows an ultimate instant complexity if the channel matrix is insufficient, i.e., if the condition number of channel matrix is large or instant noise power is high. Therefore, the base station has difficulty using the random complexity of the SD detecting method with a large standard deviation, with respect to a substantial application having limited power and low latency tolerance.

In addition, the QRD-M method was proposed as a compromise to provide a closer match between performance and complexity. That is, in the QRD-M method, the amount of operation necessary for signal detection is fixed regardless of the channel condition or noise power. However, the QRD-M method is disadvantageous in that, in a search to achieve a certain degree of complexity for a detecting process, if the channel matrix is sufficient, it ignores that fact that a relatively small number of operations may be performed to acquire precisely the same performance.

### SUMMARY OF THE INVENTION

An aspect of the present invention is to address the above problems and/or disadvantages and to provide at least the advantages described below. Accordingly, and an aspect of the present invention is to provide a signal detecting method for spatial multiplexing multiple-input multiple-output (MIMO) systems that can detect signals using a QR decomposition with M (QRD-M) algorithm where the upper and lower bounds of complexity are limited.

In accordance with an aspect of the present invention, a method for detecting signals in spatial multiplexing multiple-input multiple-output (MIMO) systems is provided. The method includes receiving signals, limiting upper and lower bounds of a complexity in a QR-decomposition with M (QRD-M) algorithm, and detecting the received signals using the QRD-M algorithm.

Preferably, the complexity of the QRD-M algorithm limits the upper bound using a predetermined size of a search tree.

Preferably, the QRD-m algorithm fixes the radius of a search sphere by including the optimum solution and thus does not perform unnecessary operations.

Preferably, the received signals are independent streams that are simultaneously transmitted from different antennas.

Preferably, the MIMO systems are operated in spatial multiplexing.

Preferably, the method is applied to an orthogonal frequency division multiplexing (OFDM).

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will become more apparent from the following description taken in conjunction with the accompanying drawings, in which:

FIG. 1 is a flowchart describing an upper-lower bounded complexity (ULBC) QR-decomposition with M (QRD-M) algorithm used in spatial multiplexing multiple-input multiple-output (MIMO) systems according to an exemplary embodiment of the present invention;

FIG. 2A to FIG. 2C are diagrams describing an operation complexity of a ULBC QRD-M algorithm used in spatial multiplexing MIMO systems according to an exemplary embodiment of the present invention;

FIG. 3 is a diagram illustrating a transmission frame when four transmitting antennas are used in spatial multiplexing MIMO systems according to an exemplary embodiment of the present invention;

FIG. 4 is a graph describing the performance of a QRD-M algorithm used in spatial multiplexing MIMO systems according to an exemplary embodiment of the present invention; and

FIG. 5 is a graph describing the average complexity of a QRD-M algorithm used in spatial multiplexing MIMO systems according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, exemplary embodiments of a signal detecting method for spatial multiplexing multiple-input multiple-output (MIMO) systems according to the present invention are described in detail with reference to the accompanying drawings.

The MIMO systems according to an exemplary embodiment of the present invention employ a spatial multiplexing manner and can be used with an orthogonal frequency division multiplexing (OFDM) system having ignorable inter-carrier interference. The MIMO systems can be modeled by the following Equation (1),

r=Hx+v (1)

where rε [symbol] denotes a received vector, Vε [symbol] denotes Gaussian noise having dispersion σ² and Hε [symbol] denotes full column rank complex channel matrix whose element h_{i,j} is a transfer function between i-th receiving antenna and j-th transmitting antenna.

If Nᵣ=Nₜ=N and Nₛ=2×Nₜ are expressed in a real space dimension, Equation (1) can be mapped to real space, [symbol] , as following Equation (2),

$$[ \begin{matrix} ( r ) \\ ( r )\end{matrix} ] = [ \begin{matrix} ( H ) & - ( H ) \\ ( H ) & ( H )\end{matrix} ] [ \begin{matrix} ( x ) \\ ( x )\end{matrix} ] + [ \begin{matrix} ( v ) \\ ( v )\end{matrix} ] \qquad ( 2 )$$

where [symbol] and [symbol] denote a real part and an imaginary part of x.

For short, Equation (2) is expressed as an equation rᵣ=HᵣXᵣ+vᵣ, where rᵣε [symbol] , Hᵣε [symbol] vᵣε [symbol] , and xᵣε

[symbol]

If the systems are operated with respect to the transmitted vector xᵣ, Hᵣ generates lattice, Lₛ(Hᵣ):={z=Hᵣxᵣ|xᵣε [symbol] }. Therefore, Equation (1) refers to a result where the lattice point z is disturbed by noise vᵣ.

After that, if QR-decomposition is used, the real channel matrix Hᵣ can be decomposed to a product of a unit matrix Q and a upper triangular matrix R. If both sides of Equation (2) are multiplied by the inverse of Q, i.e., a transpose matrix, Equation (3) can be derived as follows,

y=Rxᵣ+n (3)

where y=Q^{T}rᵣ and n=Q^{T}vᵣ.

Equation (3) is used as a starting point for the signal detecting method including a QRD-M algorithm of the MIMO systems, according to an exemplary embodiment of the present invention.

In an embodiment of the present invention, 3GPP spatial channel model extended (SCME) is used. More specifically, a channel is composed of six main paths shown as the Dirac delta function in a delay domain, where each main path includes 20 independent sub-paths. Respective sub-paths are grouped as a mid path. Each main path includes three or four mid paths, according to channel scenarios. With respect to each main path, a sub-urban macro scenario including three mid paths is considered. Following Table 1 describes power and delay profiles at carrier frequency f_{c}=3.7 GHz. Delay profile is determined as the average number of delay samples of three mid paths included in each main path, where summation of power profile values of all main paths is 1.

TABLE 1

| | Path | | | | | |
|---|---|---|---|---|---|---|
| | 1 | 2 | 3 | 4 | 5 | 6 |
| Delay | 0.33 | 2.33 | 4.67 | 12.67 | 42.67 | 87.33 |
| Power | 0.526 | 0.126 | 0.285 | 0.048 | 0.012 | 0.003 |

In the following description, as an embodiment of the signal detecting method of MIMO systems according to an exemplary embodiment of the present invention, an upper-lower bounded complexity (ULBC) QRD-M algorithm is described that limits the upper and lower bounds of the complexity.

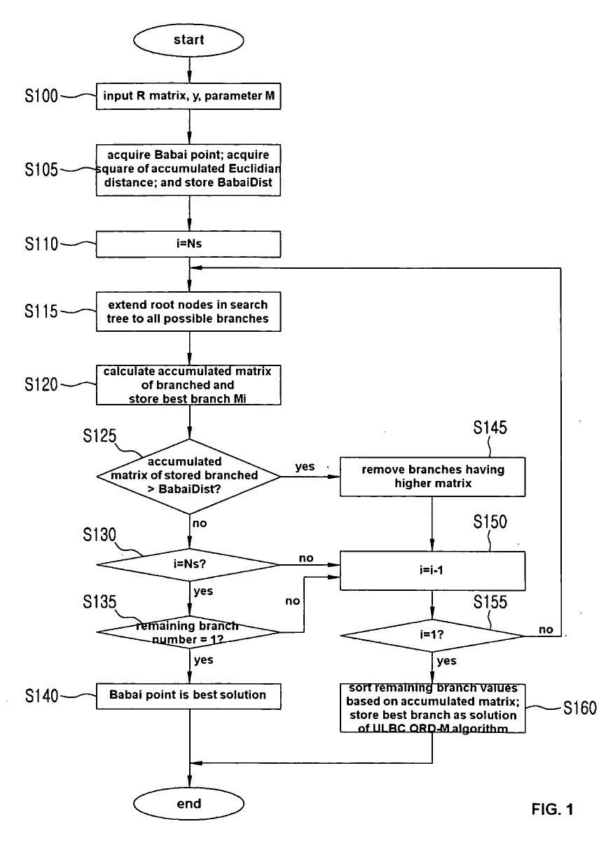

FIG. 1 is a flowchart describing a ULBC QRD-M algorithm used in spatial multiplexing MIMO systems according to an exemplary embodiment of the present invention. As shown in FIG. 1, the ULBC QRD-M algorithm employs a Babai point solution. The Babai point solution was described in Combinatorica, vol. 6, no. 1, March 1986, pp 1-13, by L. Babai, entitled “On Lovasz' Lattice Reduction and the Nearest Point Problem”, whose detailed description is omitted in this application.

When the ULBC QRD-M algorithm starts, R matrix, y, and parameter M are input (S100). When the Babai point and the square of the accumulated Euclidean distance are acquired, these values are stored as the BabaiDist (S105). After that, the detecting stage i is set by the total stage Ns (S110). A root node of a search tree is extended to all possible branches (S115). A branch accumulated matrix is calculated and the best branch Mᵢ is stored (S120).

After that, it is compared whether the accumulated matrix of stored branches is higher than the BabaiDist (S125). When the accumulated matrix of stored branches is not higher than BabaiDist at step S125, it is determined whether i=Nₛ (S130). When i=Ns at step S130, it is determined whether the number of remaining branch is 1 (S135). When the number of remaining branch is 1 at step S135, it is concluded that the Babai point is the best solution (S140) and then the algorithm is terminated.

On the contrary, when the accumulated matrix of stored branches is higher than the BabaiDist at step S125, branches having a matrix higher than the BabaiDist are removed (S145).

Also, when i is not Nₛ at step S130 or the number of remaining branch is not 1 at step S135, i is decreased by 1, i.e., i=i−1 (S150). In addition, after performing step S145, i is decreased by 1 at step S150.

After performing step S150, it is determined whether i=1 (S155). When i=1 (S155), the remaining branches are sorted based on the accumulated matrix and the best branch is stored as the solution of the ULBC QRD-M algorithm (S160). After that, the procedure of the algorithm is terminated.

On the contrary, when i is not 1 at step S155, the procedure is returned to step S115 and then repeated until i is 1.

In the ULBC QRD-M algorithm of the spatial multiplexing MIMO system, shown in FIG. 1, selecting the BabaiDist as the initial radius allows for the following motives.

First, if the Babai point is the best point of the lattice points that are acquired by the conventional QRD-M algorithm, calculating the BabaiDist is to return the solution that is used for the completion of the detecting process at step 1.

Second, the other references defining a search radius derive an empty set of the solution. Therefore, the radius must be increased and the detecting operation must be re-initialized. On the contrary, the search radius includes a plurality of lattice points and thus may be large to such an extent that the operation complexity increases.

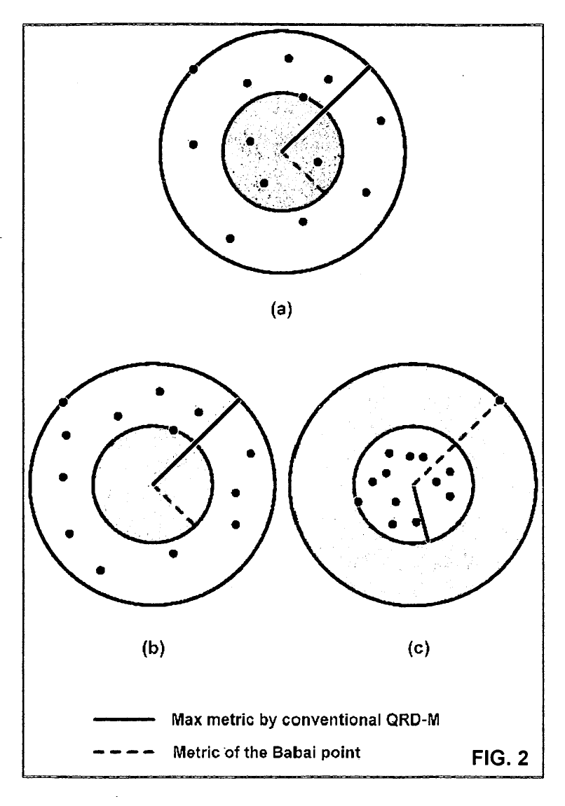

FIG. 2A to FIG. 2C are diagrams describing an operation complexity of a ULBC QRD-M algorithm used in spatial multiplexing MIMO systems according to an exemplary embodiment of the present invention.

More specifically, FIG. 2A shows a view describing a general scenario, where the Babai point is closer to the received vector than the set of points acquired by the conventional QRD-M algorithm. Therefore, these points are removed in the process of detection and the average number of visited nodes is reduced.

FIG. 2B shows the lower bound of the complexity, which is the best case. This case can be implemented when the Babai point is the lattice point closest to the received vector. Therefore, the lower bound of the number of visited nodes can be expressed by the following Equation (4),

f_{ULBC}^{LB}Nₛ+C^{1/2} (4)

where C denotes the size of modulation set and Nₛ denotes the number of visited nodes to acquire the Babai point. For example, C is 4 in the quadrature phase-shift keying (QPSK).

FIG. 2C shows the upper bound of the complexity, which is the worst case. This case can be implemented when the Babai point is farther from the received vector than the farthest point acquired by the conventional QRD-M algorithm. Therefore, the upper bound of the number of visited nodes can be expressed by the following Equation (5),

f_{ULBC}^{UB}=F_{QRD-M}+nₛ (5)

where f_{QRD-M} denotes the number of visited nodes in the conventional QRD-M algorithm.

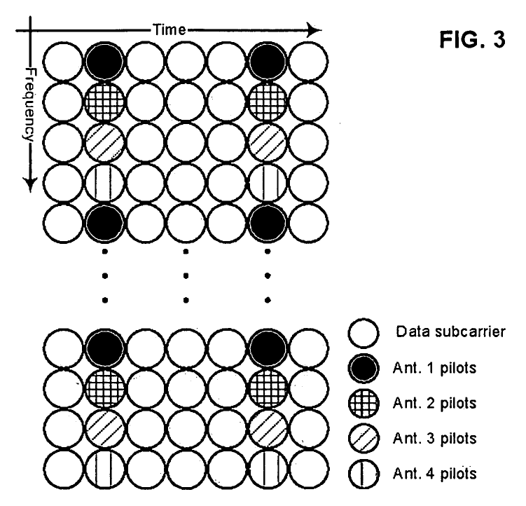

In the following description, a performance comparison is made between the ULBC QRD-M algorithm of the spatial multiplexing MIMO systems, according to an exemplary embodiment of the present invention, and the SD algorithm, and the conventional QRD-M algorithm, with reference to FIG. 3 to FIG. 5.

FIG. 3 is a diagram illustrating a transmission frame when four transmitting antennas are used in spatial multiplexing MIMO systems according to an exemplary embodiment of the present invention. As shown in FIG. 3, the pilots of different antennas are orthogonal to each other and inserted into the 2^{nd} and 6^{th} OFDM symbols. After a ZF algorithm estimates channels at the pilot positions, interpolation is made with respect to time and frequency domains and thus channel coefficients are estimated at data positions. The frame structure shown in FIG. 3 can be used in a certain number of transmitting antennas by adjusting the pilot density.

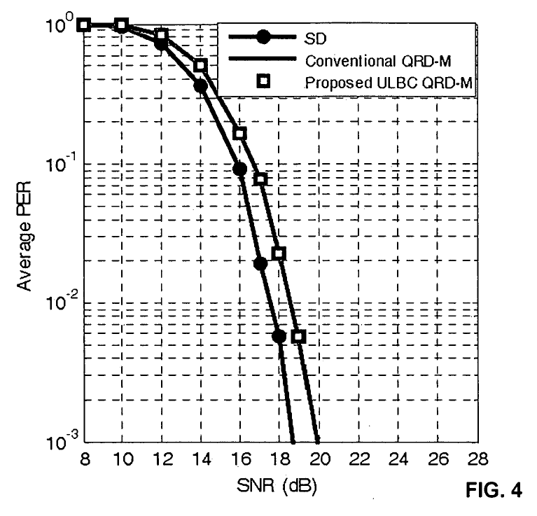

FIG. 4 is a graph describing performance of a QRD-M algorithm used in spatial multiplexing MIMO systems according to an exemplary embodiment of the present invention. That is, the PER performance of the ULBC QRD-M algorithm of the spatial multiplexing MIMO systems according to an exemplary embodiment of the present invention is compared to those of the SD algorithm and the conventional QRD-M algorithm. As shown in FIG. 4, the performance of the ULBC QRD-M algorithm of the spatial multiplexing MIMO systems according to an exemplary embodiment of the present invention is identical to that of the conventional QRD-M algorithm. This means that solutions, acquired by the ULBC QRD-M algorithm of the spatial multiplexing MIMO systems according to an exemplary embodiment of the present invention, are within the solutions that are acquired by the conventional QRD-M algorithm.

At the packet error rate (PER) of 10⁻², in terms of signal to noise ratio (SNR), the SD algorithm illustrates a superior performance of approximately 1 dB to any one of the conventional QRD-M algorithm and the ULBC QRD-M algorithm according to an exemplary embodiment of the present invention. Here, with respect to 16 QAM, q=C^{1/2}=4 and M=[q, q², q³, . . . , qⁿ].

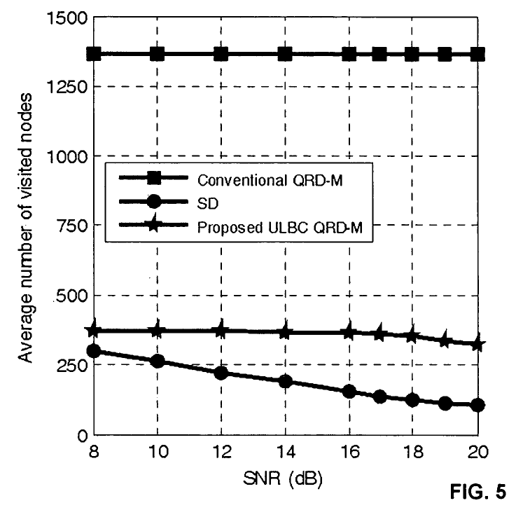

FIG. 5 is a graph describing the average complexity of a ULBC QRD-M algorithm used in spatial multiplexing MIMO systems according to an exemplary embodiment of the present invention. As shown in FIG. 5, the SD algorithm can achieve the best average complexity and the conventional QRD-M algorithm has a relatively high complexity, which is although constant. On the contrary, the ULBC QRD-M algorithm according to an exemplary embodiment of the present invention can achieve the same performance as the conventional QRD-M algorithm using only 26% of the operation amount that the conventional QRD-M algorithm requests. The ULBC QRD-M algorithm according to an exemplary embodiment of the present invention has the biggest advantage in that it has a relatively low average complexity and limits the upper bound of the complexity as defined by Equation (5). The low average complexity of the ULBC QRD-M algorithm can be achieved because all branches having an accumulated matrix greater than the Babai point are removed.

As described above, the signal detecting method for spatial multiplexing MIMO systems, according to an exemplary embodiment of the present invention, uses the QRD-M algorithm limiting the upper and lower bounds. This QRD-M algorithm of the MIMO systems, according to an exemplary embodiment of the present invention, can achieve a 74% reduction in the estimated operation complexity of the conventional QRD-M algorithm, but can exert the same performance as the conventional QRD-M algorithm. Therefore, the QRD-M algorithm of the MIMO systems according to an exemplary embodiment of the present invention can replace the SD algorithm and the conventional QRD-M algorithm and can be applied to substantial applications.

That is, the signal detecting method for spatial multiplexing MIMO systems, according to an exemplary embodiment of the present invention, can effectively reduce the amount of operation generated while detecting signals, using the QRD-M algorithm where upper and lower bounds of the complexity are limited.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims and their equivalents.

What is claimed is:

1. A method for detecting signals in spatial multiplexing multiple-input multiple-output (MIMO) systems, the method comprising:
receiving signals;
limiting upper and lower bounds of a complexity in a QR-decomposition with M (QRD-M) algorithm; and
detecting the received signals using the QRD-M algorithm.

2. The method of claim 1, wherein the complexity of the QRD-M algorithm limits the upper bound using a predetermined size of a search tree.

3. The method of claim 1, wherein limiting upper and lower bounds of a complexity comprises:
acquiring the Babai point in the QRD-M algorithm;
calculating an accumulated Euclidean distance from a received vector;
removing remaining branches that do not satisfy the comparison condition between the Babai point and the accumulated Euclidean distance; and
fixing the radius of a search sphere by including the optimum solution and limiting the lower bound of the complexity.

4. The method of claim 1, wherein the received signals are independent streams that are simultaneously transmitted from different antennas.

5. The method of claim 1, wherein the MIMO systems are operated in spatial multiplexing.

6. The method of claim 1, wherein the method is applied to an orthogonal frequency division multiplexing (OFDM).
